(19) United States
(12) Patent Application Publication
(10) Pub. No.: US 2018/0052643 A1
(43) Pub. Date: Feb. 22, 2018

(54) IMAGE FORMING APPARATUS, CONTROL METHOD THEREOF, AND STORAGE MEDIUM

(71) Applicant: CANON KABUSHIKI KAISHA, Tokyo (JP)

(72) Inventor: Minoru Fujisawa, Matsudo-shi (JP)

(21) Appl. No.: 15/678,926

(22) Filed: Aug. 16, 2017

(30) Foreign Application Priority Data
Aug. 18, 2016 (JP) 2016-160690

(51) Int. Cl. G06F 3/12; G06F 21/60; H04N 1/00

(52) U.S. Cl. CPC G06F 3/1207; G06F 3/1259; G06F 21/608; H04N 1/00408; G06F 3/1238; G06F 3/1288; G06F 3/1206

(57) ABSTRACT

An image forming apparatus including one or a plurality of control units, the control unit being configured to perform acquiring identification information of print data, acquiring the print data indicated by the identification information from the server, causing the image forming unit to execute image formation based on the print data, storing, after completion of the image formation, information indicating that the completion is not yet notified to the server into the storage unit and updating, after the completion of the image formation is notified to the server, the information so that the information indicates that the completion has been notified to the server, and notifying the server of the completion of the image formation, without resuming the image formation, based on the information indicating that the completion is not yet notified to the server when the image forming apparatus is powered on.

### BACKGROUND OF THE INVENTION

### Field of the Invention

The present invention relates to an image forming apparatus that executes a print job input to a network server, a control method thereof, and a storage medium.

### Description of the Related Art

There is a conventional system for providing a cloud service for printing. In the system, a network server receives image data input from a client terminal such as a mobile terminal, and converts the received image data into print data. Further, a printer downloads the print data and prints the downloaded print data. Japanese Patent Application Laid-Open No. 2015-92394 discusses a related technique. According to the technique, a server converts input image data into print data, and then notifies a printer of the presence of the print data by using a specific communication scheme with the printer. The printer downloads the print data from the server and then executes print processing for the print data.

Japanese Patent Application Laid-Open No. 2013-6304 discusses another related technique. According to the technique, a printer performs management, for a printing request provided from an apparatus such as a personal computer (PC) without intervention of a network server. Specifically, the printer manages a print-data receiving state, a print execution status, and actual print data. Whether to perform reprinting at a resumption after a shutdown of the printer is thereby controlled.

In general, in a cloud print service, a network server in a cloud manages print data, and also manages the print status of the print data. One reason for this is that there is a case where a client terminal, which inputs image data via the cloud, is away from a location where the printer is installed. To confirm whether the printer has printed the image data input from the client terminal, it is necessary to view the print status on a management website of the cloud print service. It is thus necessary to recognize the print status on the cloud side. However, since an apparatus that actually performs the printing is the printer, the printer notifies the print status to the network server in the cloud, and the server manages the print status based on the notified information.

However, the above-described existing techniques have the following issue. Assume that a shutdown of the printer occurs for some reason in a period between start and end of print processing. In this case, when the power is subsequently turned on, it is necessary to notify an execution status to the network server in the cloud, while re-performing the print processing that has started before the shutdown. In such a case, in the cloud print service, since the execution status is managed in the server, the actual print status in the printer and the print status managed by the server may be different. Accordingly, the reprinting processing or the notification of the execution status at the subsequent power-on may be unsuccessful, depending on the timing of the occurrence of the shutdown.

### SUMMARY OF THE INVENTION

Embodiments of the present invention is directed to an image forming apparatus, a control method thereof, and a storage medium. Even if a shutdown of the image forming apparatus occurs in a period between start and end of a job in a cloud system, the image forming apparatus suitably executes resumption processing to be performed when the power is subsequently turned on, and accurate processing for notifying a network server of an execution status.

According to embodiments of the present invention, an image forming apparatus capable of communicating with a server, and including a nonvolatile storage unit capable of storing information and an image forming unit for forming an image on a sheet based on print data, includes one or a plurality of control units including a processor or a processing circuit for executing a program in a memory, the control unit being configured to perform acquiring identification information of print data, acquiring the print data indicated by the identification information from the server, causing the image forming unit to execute image formation based on the print data, storing, after completion of the image formation, information indicating that the completion is not yet notified to the server into the storage unit and updating, after the completion of the image formation is notified to the server, the information so that the information indicates that the completion has been notified to the server, and notifying the server of the completion of the image formation, without resuming the image formation, based on the information indicating that the completion is not yet notified to the server when the image forming apparatus is powered on.

Further features of the present invention will become apparent from the following description of exemplary embodiments with reference to the attached drawings.

### BRIEF DESCRIPTION OF THE DRAWINGS

FIG. 1 is a diagram illustrating a network configuration according to an exemplary embodiment.

FIG. 2 is a diagram illustrating a hardware configuration of an image forming apparatus according to an exemplary embodiment.

FIG. 3 is a diagram illustrating a hardware configuration of a server according to an exemplary embodiment.

FIG. 4 is a diagram illustrating a software configuration of an image forming apparatus according to an exemplary embodiment.

FIG. 5 is a diagram illustrating a software configuration of a server according to an exemplary embodiment.

FIG. 6 illustrates a print processing sequence according to a conventional example.

FIG. 7 is a diagram illustrating a sequence according to a comparative example 1 in which a shutdown occurs in the sequence according to the conventional example.

FIG. 8 is a diagram illustrating a sequence according to a comparative example 2 in which a shutdown occurs in the sequence according to the conventional example.

FIG. 9 illustrates a print processing sequence between an image forming apparatus and a server according to an exemplary embodiment.

FIG. 10 is a diagram illustrating a sequence according to a verification example 1 in which a shutdown of an image forming apparatus occurs in a sequence according to an exemplary embodiment.

FIG. 11 is a diagram illustrating a sequence according to a verification example 2 in which a shutdown of an image forming apparatus occurs in a sequence according to an exemplary embodiment.

FIG. 12 is a diagram illustrating a sequence according to a verification example 3 in which a shutdown of an image forming apparatus occurs in a sequence according to an exemplary embodiment.

FIG. 13 is a table illustrating print data association information managed in a server according to an exemplary embodiment.

FIG. 14 is a flowchart illustrating reprinting processing to be performed when power is subsequently turned on after a shutdown of an image forming apparatus according to an exemplary embodiment occurs during printing.

FIG. 15 is a flowchart illustrating print termination processing to be performed when a shutdown of an image forming apparatus according to an exemplary embodiment occurs during printing.

FIG. 16 is a diagram illustrating a user interface displayed in reprinting processing according to an exemplary embodiment.

### DESCRIPTION OF THE EMBODIMENTS

Exemplary embodiments of the present invention will be described in detail below with reference to the attached drawings. The following exemplary embodiments are not intended to limit the scope of claims, and not all the combinations of features described in the present exemplary embodiments are necessarily essential to a solution of the present invention.

### <System Configuration>

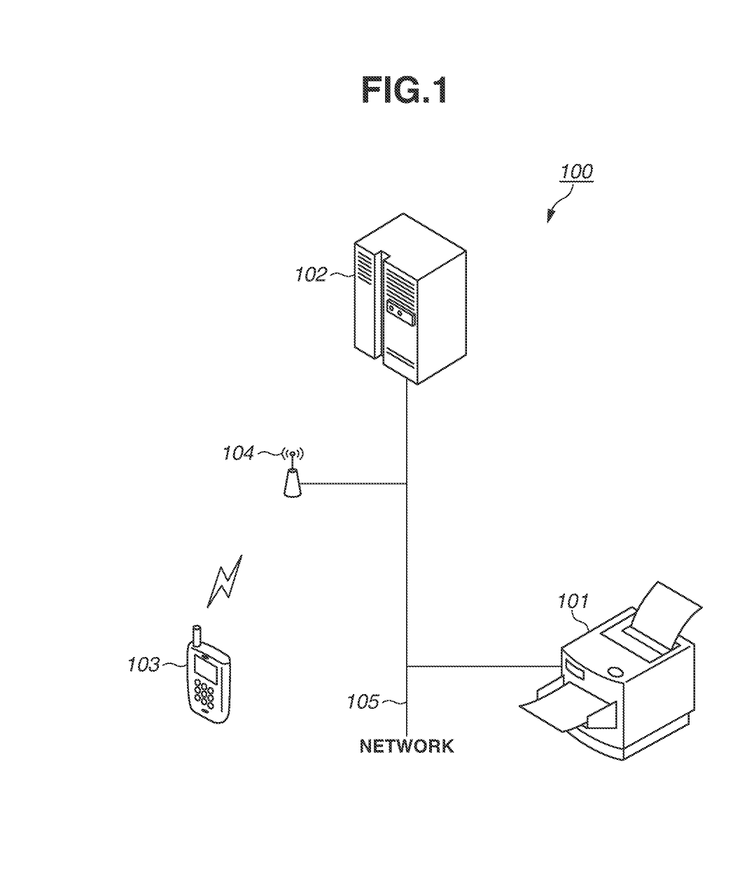

A first exemplary embodiment of the present invention will be described below. First, a configuration example of a network system according to the present exemplary embodiment will be described with reference to FIG. 1.

A system 100 includes an image forming apparatus 101, a server 102, a client terminal 103, and an access point 104. These are communicably interconnected via a network 105. The present invention is not intended to limit the above-described configuration and the number of units, and other units may be further included.

The system 100 can be configured, for example, to provide a cloud print service. For example, the image forming apparatus 101 acquires a print job input to the server 102, and executes print processing. Further, the image forming apparatus 101 notifies the server 102 of the status of the print processing. The server 102 receives a print job from the client terminal 103 such as an external terminal via the access point 104, and manages the received print job. The server 102 transmits data about the print job managed thereby to the image forming apparatus 101, in response to a request from the image forming apparatus 101. Furthermore, the server 102 manages the print job, according to a print status notified from the image forming apparatus 101. In this way, the client terminal 103 is connectable to the network 105 via the access point 104, and thus can communicate with the server 102.

### <Hardware Configuration of Image Forming Apparatus>

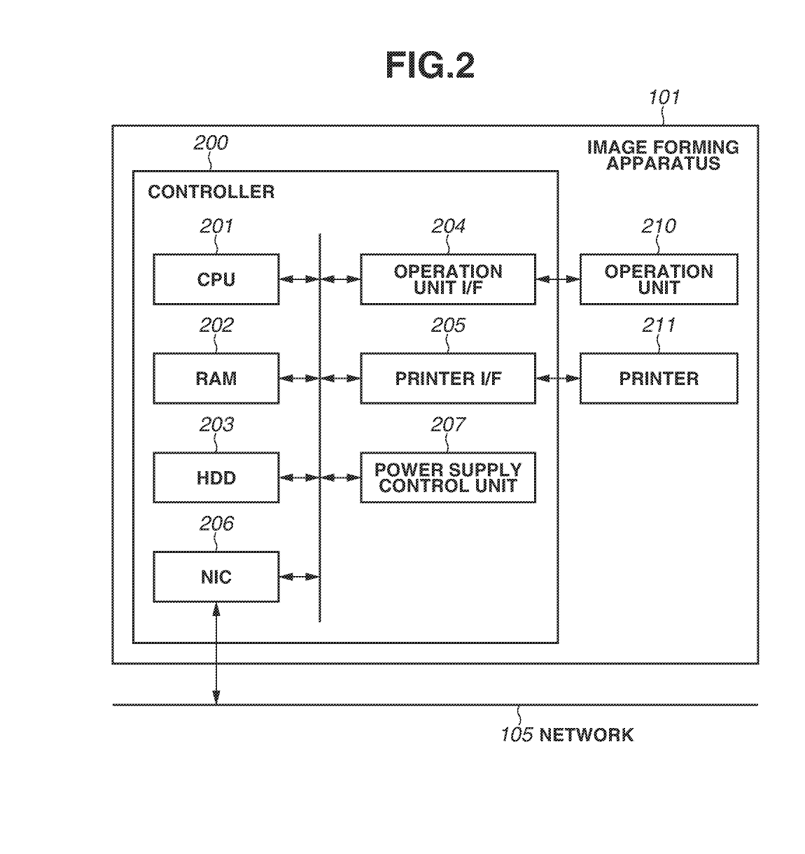

Next, a hardware configuration of the image forming apparatus 101 will be described with reference to FIG. 2. The image forming apparatus 101 includes a controller 200, an operation unit 210, and a printer 211. Further, the controller 200 includes a central processing unit (CPU) 201, a random access memory (RAM) 202, a hard disk drive (HDD) 203, an operation unit interface (I/F) 204, a printer I/F 205, a network interface card (NIC) 206, and a power supply control unit 207.

The image forming apparatus 101 is connected to the network 105 via the NIC 206. The CPU 201 executes a software program of the image forming apparatus 101 and thereby comprehensively controls the entire image forming apparatus 101. The RAM 202 provides a work area, which is to be used for temporary storage of data, and various kinds of task processing to be performed after firmware start of the image forming apparatus 101, when the CPU 201 controls the image forming apparatus 101. The HDD 203 is a storage that functions as a nonvolatile storage unit. The HDD 203 is used for purposes such as storage of various setting values of the image forming apparatus 101, and spooling of print data.

The operation unit 210 includes a liquid crystal panel. The operation unit I/F 204 causes the operation unit 210 to display various operation screens, and transmits instructions input via the operation screen to the CPU 201. The printer I/F 205 controls the printer 211 to print an image based on image data on a recording medium. In printing, the printer I/F 205 may perform processing such as color conversion, filter processing, and resolution conversion, on print data.

The NIC 206 is connected to the network 105, and thereby controls data communication with an external apparatus (the server 102) on the network 105. The power supply control unit 207 is a power supply of the image forming apparatus 101, and performs power control at power-on/off and during sleep.

### <Hardware Configuration of Server>

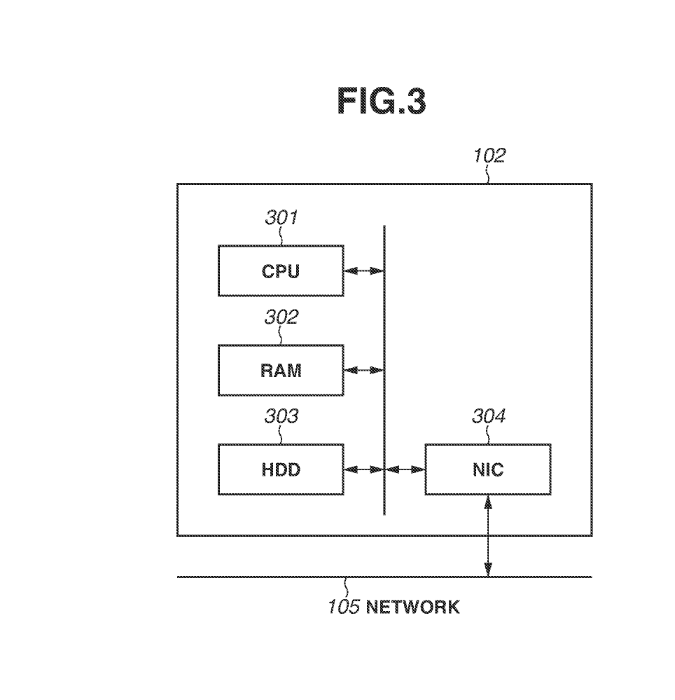

Next, a hardware configuration of the server 102 will be described with reference to FIG. 3. The server 102 includes a CPU 301, a RAM 302, a HDD 303, and an NIC 304. The server 102 is connected to the network 105 via the NIC 304.

The CPU 301 executes a software program of the server 102 and thereby controls the entire server 102. The RAM 302 provides a work area, which is to be used for temporary storage of data, and various kinds of task processing to be performed after firmware start of the image forming apparatus 101, when the CPU 301 controls the server 102. The HDD 303 is a storage used for purposes such as storage of various setting values and management information of the server 102, and storage of print data. The NIC 304 is connected to the network 105, and thereby controls data communication with the image forming apparatus 101 via the access point 104 on the network 105.

### <Software Configuration of Image Forming Apparatus>

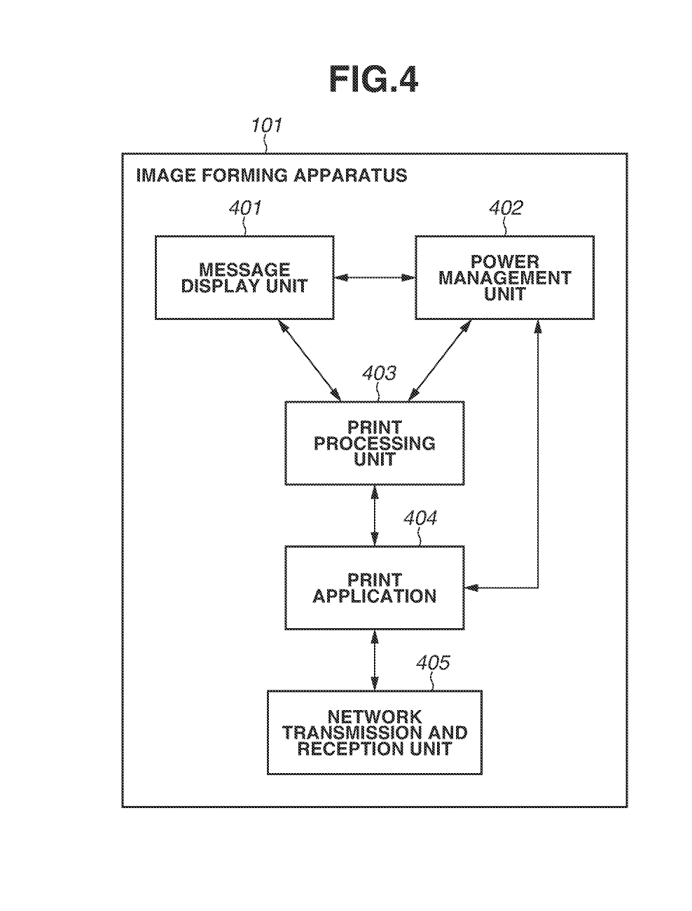

Next, a configuration example of software controlled by the CPU 201 in the image forming apparatus 101 will be described with reference to FIG. 4. The image forming apparatus 101 includes a message display unit 401, a power management unit 402, a print processing unit 403, a print application 404, and a network transmission and reception unit 405, as a software configuration.

The message display unit 401 displays various settings for printing, via the operation unit 210. Further, the message display unit 401 receives an execution status (a print status) and a log from the print processing unit 403, and displays the received execution status and log to an operator of the image forming apparatus 101. The execution status indicates a status of job execution performed by the image forming apparatus 101. For example, the execution status indicates a print status, if the job is a print job. The power management unit 402 performs control at power-on/off and during sleep, for the power supply control unit 207 illustrated in FIG. 2. The print processing unit 403 performs image analysis processing such as color conversion, filtering, and resolution conversion, for print data received from outside. The print processing unit 403 further performs processing for printing on a print sheet and paper discharge by the printer 211.

The print application 404 performs various kinds of communication processing for printing, with the server 102, via the network transmission and reception unit 405. The various kinds of communication processing at least include receiving notification of presence of print data as well as the print data from the server 102, requesting the server 102 to permit downloading of print data, and processing for notifying an execution status change. In addition, according to a change in the execution status of a print job, the print application 404 performs storage, change, or deletion of information indicating the execution status of the print job, for the HDD 203.

The network transmission and reception unit 405 generates network packets in response to for various transmission instructions from the print application 404, and transmits the generated network packets to the server 102. Further, the network transmission and reception unit 405 receives notification and response data from the server 102, and performs analysis processing therefor. For example, in a case where the server 102 is a cloud server on the Internet, the network transmission and reception unit 405 executes processing according to network protocols such as Hypertext Transfer Protocol (HTTP), Secure Socket Layer (SSL), and Extensible Messaging and Presence Protocol (XMPP).

### <Software Configuration of Server>

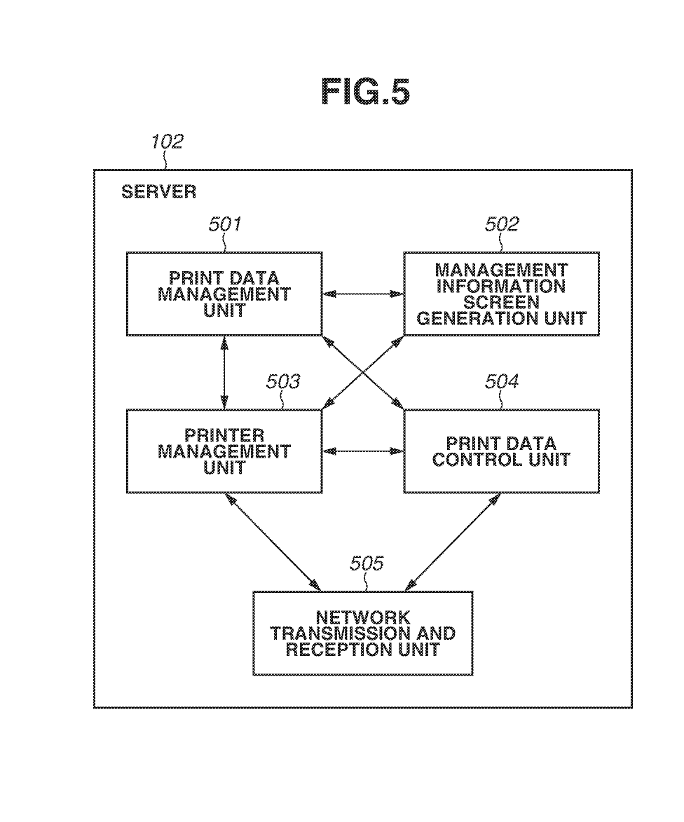

Next, a configuration example of software controlled by the CPU 301 in the server 102 will be described with reference to FIG. 5. The server 102 includes a print data management unit 501, a management information screen generation unit 502, a printer management unit 503, a print data control unit 504, and a network transmission and reception unit 505, as a software configuration.

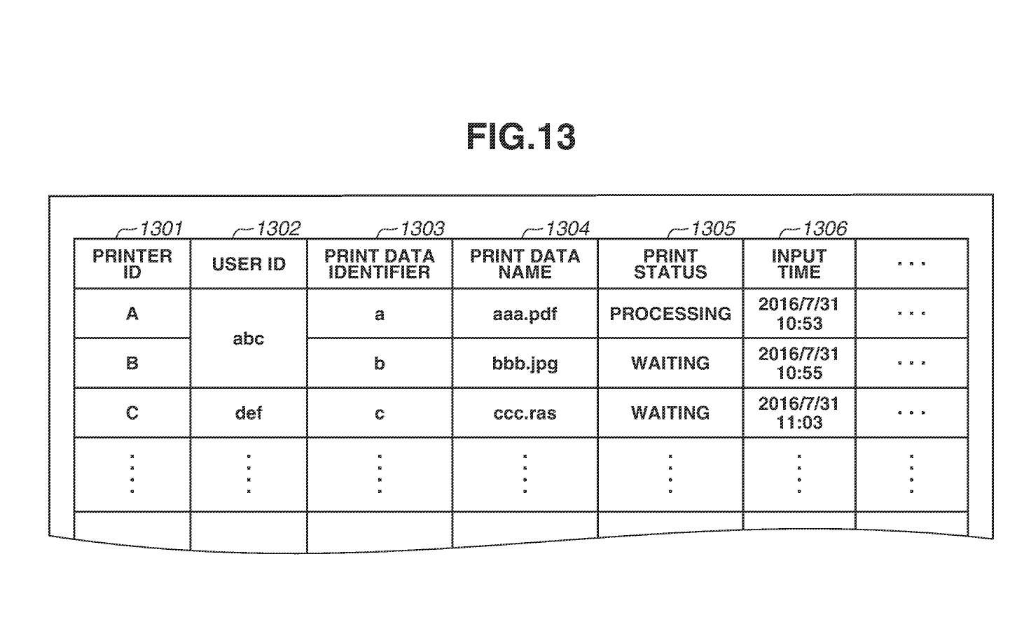

The print data management unit 501 stores print data input from the client terminal 103 via the network 105, into the HDD 303, and manages the print data. Information indicating the print data being managed includes not only actual print data, but also at least information (a user ID 1302, a print data identifier 1303, a print data name 1304, a print status (an execution status) 1305, and an input time 1306) described below with reference to FIG. 13. The print data management unit 501 receives these pieces of information from the client terminal 103 and manages the received pieces of information. In addition, in a case where the server 102 receives notification of an execution status change from the image forming apparatus 101, the print data management unit 501 updates the management information indicating the print status 1305 to be described below.

The management information screen generation unit 502 acquires information of print data managed by the print data management unit 501, and information of a printer managed by the printer management unit 503. The management information screen generation unit 502 generates a management information screen based on the acquired information. The management information screen represents a screen displayed at a user interface on the server 102, a screen of a printer available on the Internet, and a screen of a print-data management information site. The printer management unit 503 stores various kinds of information of a printer managed by the server 102 in the HDD 303. The various kinds of information of the printer include various print attribute values supported by the printer, and the current status of the printer. Examples of the various print attribute values include print sheet sizes supported by the printer, functions of polychrome printing ad monochrome printing, presence/absence of support of two-sided printing, and the number of sheet feeding trays. Examples of the current status of the printer include toner remaining amounts, presence/absence of sheets in the sheet feeding trays presence/absence of paper-jam detection, and a cover open/close status, of the printer.

The server 102 receives a request from the client terminal 103. The request specifies which print data to be processed by which printer. In response to the request, the printer management unit 503 and the print data management unit 501 perform processing by operating together. The server 102 can thereby identify which printer is to be instructed to print the print data input from the client terminal 103.

The print data control unit 504 executes print-data generation processing and image conversion processing. The format of the print data input from the client terminal 103 may not be processed depending on the printer managed by the server 102. Accordingly, the print data control unit 504 acquires information of the printer intended to perform the print processing from the printer management unit 503, and thereby confirms a print data format supported by the printer. In a case where the format of the input print data is not supported, the print data control unit 504 performs image conversion into the print data format supported by the printer.

The network transmission and reception unit 505 generates network packets in response to various transmission instructions from the printer management unit 503 and the print data control unit 504, and transmits the generated network packets to the image forming apparatus 101. Further, the network transmission and reception unit 505 receives notification and various requests from the image forming apparatus 101, and executes analysis processing therefor. For example, in a case where the server 102 is a cloud server on the Internet, the network transmission and reception unit 405 controls transmission and reception according to network protocols such as HTTP, SSL, and XMPP.

### CONVENTIONAL EXAMPLE

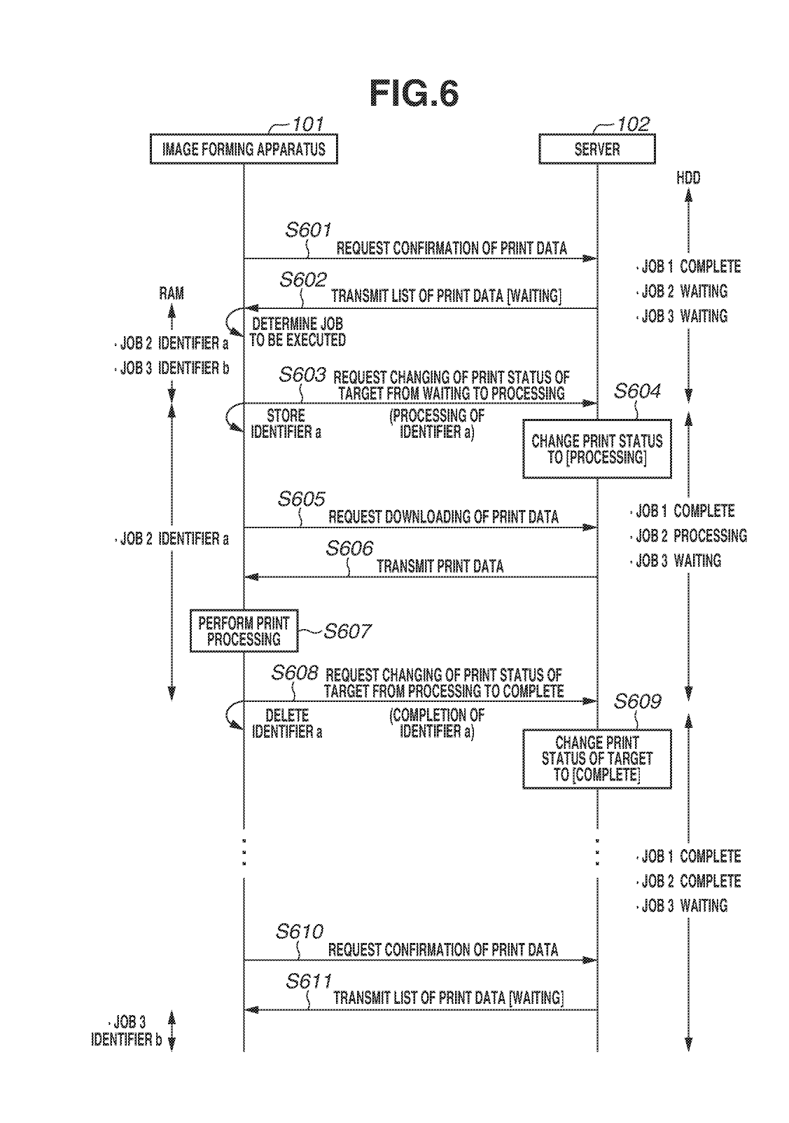

Next, a sequence in a conventional example will be described with reference to FIG. 6. In the present sequence, for print target data input from a client terminal to a server, print processing is executed between an image forming apparatus and the server. When the print data is input from the client terminal, the server notifies the image forming apparatus of the presence of the print data. This starts the print processing between the image forming apparatus and the server.

First, in step S601, the image forming apparatus issues a request for confirmation of print data to the server. Next, in step S602, in response to the request issued in step S601, the server generates a list of print data among print data managed by the server. The print data in the list is print data, for which execution of the print processing in the image forming apparatus is requested from the client terminal, and whose execution status (print status) is “waiting”. The server then transmits the generated list to the image forming apparatus, as a response to the request issued in step S601. The response includes a print data identifier assigned by the server to each piece of the print data. Here, assume that the server manages jobs 1 to 3, and the execution status of the job 1 is “complete”, while the execution status of each of the jobs 2 and 3 is “waiting”, as illustrated in FIG. 6. Accordingly, in step S602, the server transmits the list of print data including the jobs 2 and 3 to the image forming apparatus. Further, here, assume that the print data identifier of the job 2 is “a”, and the print data identifier of the job 3 is “b”.

Next, in step S603, the image forming apparatus determines print data (a predetermined job) to be printed this time as a print target, from the list transmitted in step S602. Further, the image forming apparatus issues a request to the server, requesting for changing of the execution status from “waiting” to “processing” by using the print data identifier of the print target. Furthermore, the image forming apparatus stores the identifier into a RAM of the image forming apparatus. In step S604, in response to the request issued in step S603, the server changes the status of the print target to “processing”, and notifies the image forming apparatus of the change.

Next, in step S605, the image forming apparatus issues a request for permitting downloading of the print data of the print target from the server, by using the print data identifier. Processing for the downloading of the print data includes downloading of various attribute values necessary for the print processing, in addition to the actual print data. In step S606, the server transmits the print data to the image forming apparatus in response to the request issued in step S605.

In step S607, the image forming apparatus receives the print data transmitted in step S606, and then starts the print processing. Next, in step S608, upon completion of the print processing started in step S607, the image forming apparatus issues a request to the server, requesting for changing of the execution status of the print target from “processing” to “complete”, by using the print data identifier. Further, the image forming apparatus deletes the identifier from the RAM of the image forming apparatus. Subsequently, in step S609, in response to the request issued in step S608, the server changes the execution status to “complete”.

Afterward, in step S610, the image forming apparatus issues a request for confirmation of print data to the server, when performing startup processing due to an event such as a resumption. In step S611, in response to the request issued in step S610, the server generates a list of print data whose execution status is “waiting”, and transmits the generated list to the image forming apparatus, in a manner similar to step S602. Here, the jobs 1 and 2 are changed to “complete” and thus, the list includes the job 3.

### COMPARATIVE EXAMPLE 1

Next, a sequence according to a comparative example 1 will be described. The comparative example 1 is a case where a shutdown occurs in the sequence according to the conventional example illustrated in FIG. 6. Steps similar to those in FIG. 6 are provided with the same step numbers as those in FIG. 6 and will not be described. More specifically, steps S601 to S606, step S610, and step S611 are similar to those in FIG. 6 and will not be described.

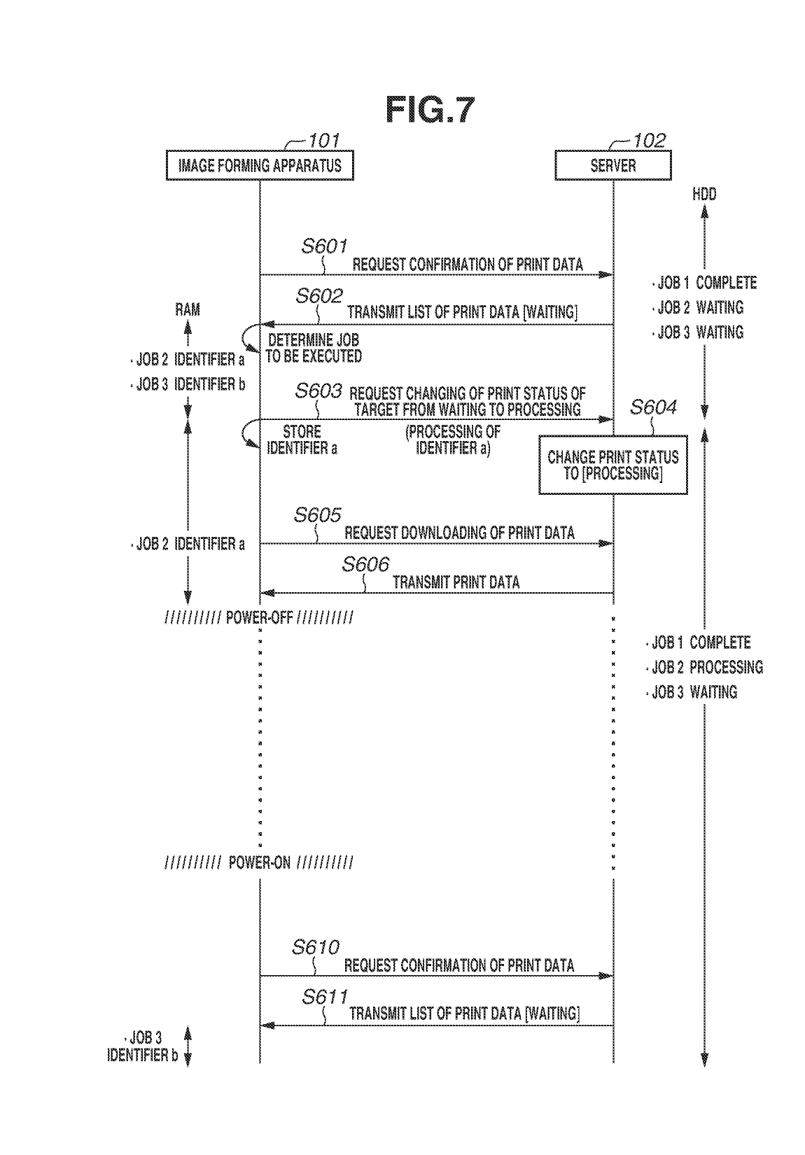

In the present sequence, a shutdown is assumed to occur in the image forming apparatus, after the print data is transmitted from the server to the image forming apparatus in step S606. In the present sequence, the processes in steps S607 to S609 described in FIG. 6 are not executed, as illustrated in FIG. 7. In other words, in the present sequence, the print processing control does not begin, and thus the identifier in the image forming apparatus is not deleted, and the control for changing the execution status in the server from “processing” to “complete” is not performed. In the comparative example 1, the identifier “a” of the job 2 stored in the RAM of the image forming apparatus disappears at the shutdown. When a resumption occurs in the image forming apparatus in such a state after the shutdown, the processes in steps S610 and S611 are executed in a manner similar to the sequence illustrated in FIG. 6.

However, in step S611, only the job 3 is a job in “waiting” and thus, the list of print data transmitted from the server to the image forming apparatus includes only the job 3, even though the job 2 is not “complete”. Thus, the print processing for the job 2 cannot be completed.

### COMPARATIVE EXAMPLE 2

Next, a sequence according to a comparative example 2 will be described. The comparative example 2 is a case where a shutdown occurs in the sequence according to the conventional example illustrated in FIG. 6. Steps similar to those in FIG. 6 are provided with the same step numbers as those in FIG. 6 and will not be described. More specifically, steps S601 to S607, step S610, and step S611 are similar to those in FIG. 6 and will not be described.

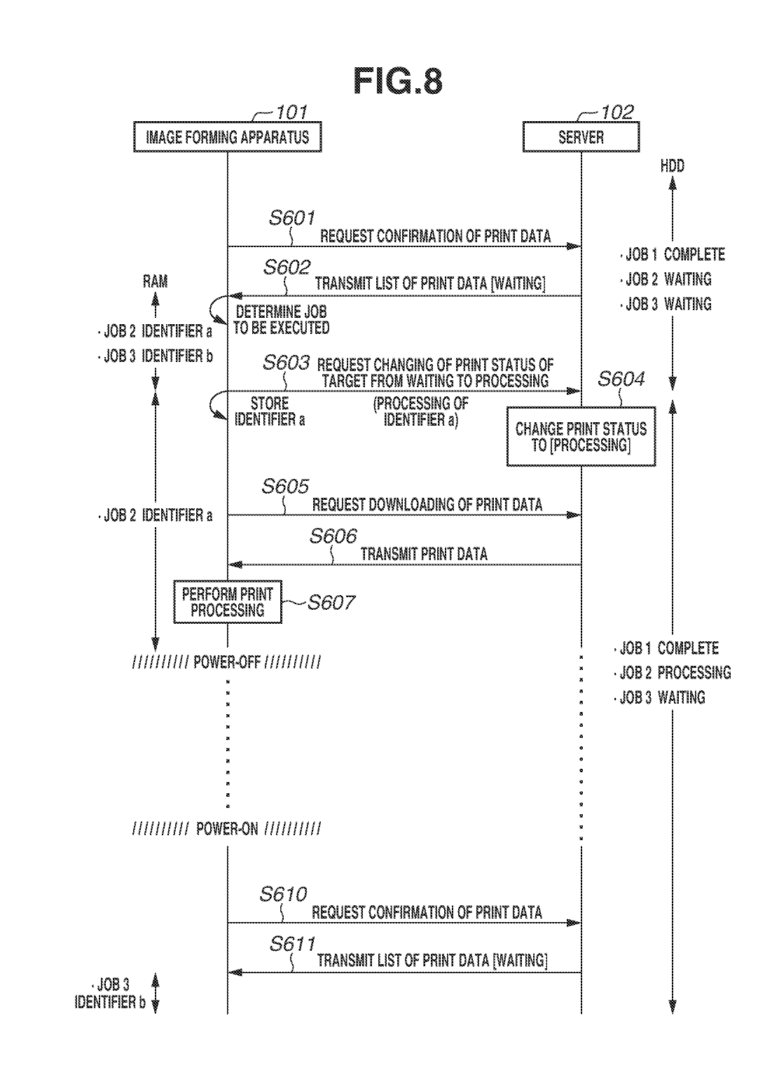

In the present sequence, a shutdown is assumed to occur in the image forming apparatus, after start of the print processing in step S607. In the present sequence, the processes in steps S608 and S609 described in FIG. 6 are not executed, as illustrated in FIG. 8. In other words, in the present sequence, although the print processing has started, the print processing is not completed. Thus, the identifier in the image forming apparatus is not deleted, and the control for changing the execution status in the server from “processing” to “complete” is not performed. In the comparative example 2, the identifier “a” of the job stored in the RAM of the image forming apparatus disappears at the shutdown. When a resumption occurs in the image forming apparatus in such a state after the shutdown, the processes in steps S610 and S611 are executed in a manner similar to the sequence illustrated in FIG. 6.

However, in step S611, even though the job 2 is not “complete”, only the job 3 is a job in “waiting”. Thus, the list of print data transmitted from the server to the image forming apparatus includes only the job 3. Accordingly, the print processing for the job 2 cannot be completed.

### Processing Sequence According to the Present Exemplary Embodiment

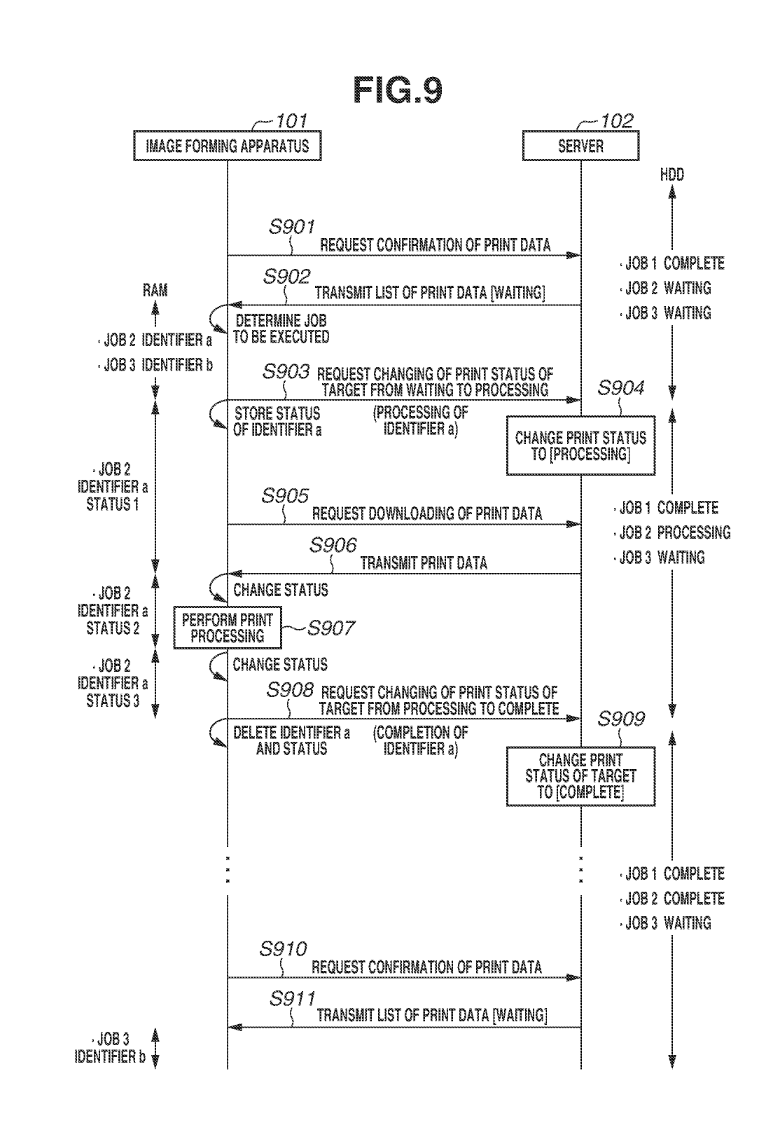

Next, a sequence according to the present exemplary embodiment will be described with reference to FIG. 9. In the sequence, for print target data input from the client terminal 103 to the server 102, the print processing is performed between the image forming apparatus 101 and the server 102. When the print data is input from the client terminal 103, the server 102 notifies the image forming apparatus 101 of the presence of the print data. This starts the print processing between the image forming apparatus 101 and the server 102.

First, in step S901, the image forming apparatus 101 issues a request for confirmation of print data to the server 102. Next, in step S902, in response to the request issued in step S901, the server 102 generates a list of print data among print data managed by the server 102. The print data in the list is print data, for which execution of the print processing in the image forming apparatus 101 is requested from the client terminal 103, and whose execution status is “waiting”. The server 102 then transmits the generated list to the image forming apparatus 101, as a response to the request issued in step S901. The response includes a print data identifier 1303 assigned by the server 102 to each piece of the print data. Here, assume that the server 102 manages jobs 1 to 3, and the execution status of the job 1 “complete”, while the execution status of each of the jobs 2 and 3 is “waiting”, as illustrated in FIG. 9. Accordingly, in step S902, the server 102 transmits the list of print data including the jobs 2 and 3 to the image forming apparatus 101. Further, here, assume that the print data identifier of the job 2 is “a”, and the print data identifier of the job 3 is “b”.

Next, in step S903, the image forming apparatus 101 determines print data to be printed this time as a print target, from the list transmitted in step S902. Further, the image forming apparatus 101 issues a request to the server 102, requesting for changing of the execution status from “waiting” to “processing”, by using the print data identifier 1303 of the print target. Furthermore, the image forming apparatus 101 stores status information (a status 1) of the identifier “a”, into the HDD 203. In step S904, in response to the request issued in step S903, the server 102 changes the status of the print target to “processing”, and notifies the image forming apparatus 101 of the change. Here, “status 1” (a first status) indicates a status in which receiving the print data of the print target is not completed.

Next, in step S905, the image forming apparatus 101 issues a request for permitting downloading of the print data of the print target from the server 102, by using the print data identifier 1303. Processing for the downloading of the print data includes downloading of various attribute values necessary for the print processing that are similar to those mentioned in the description of the printer management unit 503, in addition to the actual print data. It is desirable that the downloaded print data be stored into the HDD 203 that is a nonvolatile memory. In step S906, the server 102 transmits the print data to the image forming apparatus 101 in response to the request issued in step S905. The image forming apparatus 101 changes the status information of the print target stored in the HDD 203 from “status 1” to “status 2”. Here, “status 2” (a second status) indicates a status in which receiving the print data of the print target is complete, and the printing is in progress.

In step S907, upon completion of the reception of the print data transmitted in step S906, the image forming apparatus 101 starts the print processing, and changes the status information from “status 2” to “status 3”. Here, “status 3” (a third status) indicates a status in which the print processing is complete. The image forming apparatus 101 may be configured to perform receiving and processing the subsequent data in parallel, while sequentially performing the print processing for the print data received via the network 105, instead of performing printing after receiving the print data of the whole data size. This is to improve printing performance.

In step S908, upon completion of the print processing in step S907, the image forming apparatus 101 issues a request to the server 102, requesting for changing of the execution status of the print target from “processing” to “complete”, by using the print data identifier 1303. Further, the image forming apparatus 101 deletes the print data identifier (here, “a”) and the status information from the HDD 203. In step S909, the server 102 changes the execution status to “complete” in response to the request issued in step S908, and notifies the image forming apparatus 101 of the change.

Thereafter, the image forming apparatus 101 issues a request for confirmation of the print data to the server 102, when performing startup processing due to an event such as a resumption. In step S911, in response to the request issued in step S910, the server 102 generates a list of print data whose execution status is “waiting”, and transmits the generated list to the image forming apparatus 101, in a manner similar to step S902. Here, the jobs 1 and 2 are changed to “complete” and thus the list includes the job 3.

### VERIFICATION EXAMPLES

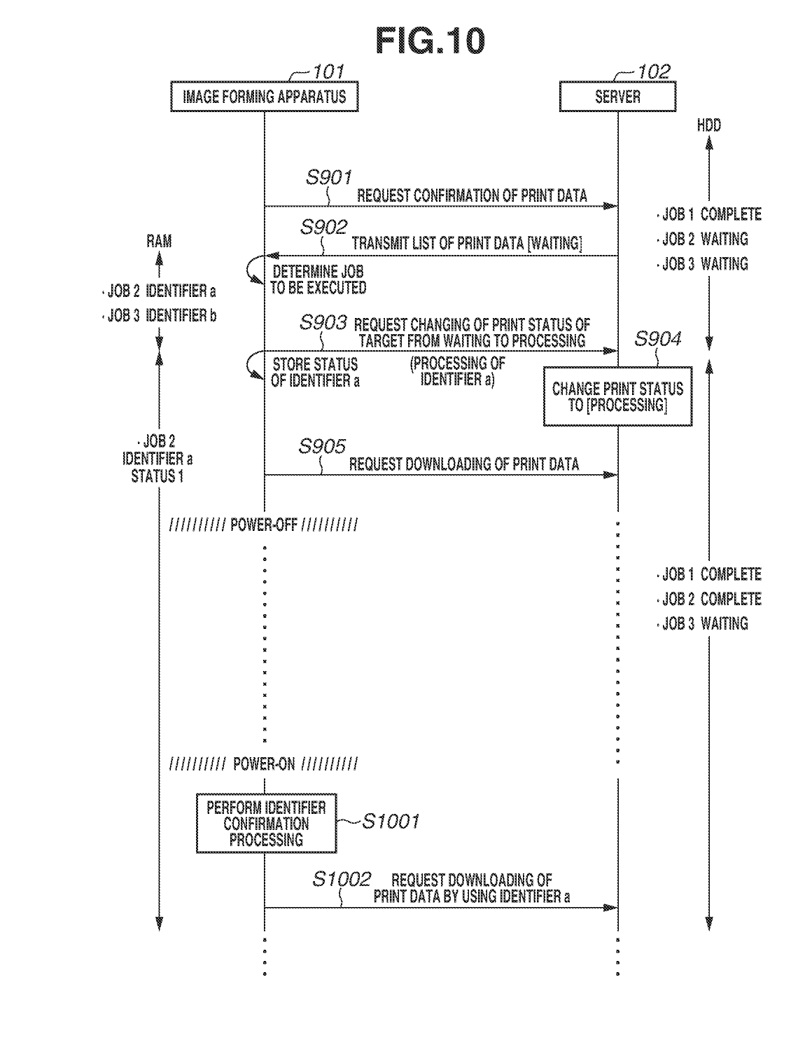

Next, verification examples in which a shutdown of the image forming apparatus 101 occurs in the processing sequence according to the present exemplary embodiment will be described with reference to FIG. 10 to FIG. 12.

### Verification Example 1

FIG. 10 illustrates an example in which a shutdown of the image forming apparatus 101 occurs, before completion of transmission of the print data from the server 102 to the image forming apparatus 101, after the image forming apparatus 101 issues a request for permitting downloading of the print data in step S905. Steps similar to those in FIG. 9 are provided with the same step numbers as those in FIG. 9 and will not be described. More specifically, steps S901 to S905 are similar to those in FIG. 9 and will not be described.

After step S905, a shutdown of the image forming apparatus 101 occurs, and then a resumption takes place. Here, the information stored in the HDD 203 of the image forming apparatus 101 indicates the print data identifier “a” corresponding to the job 2, and “status 1” representing the execution status of the job. On the other hand, the execution status of the job 2 stored in the HDD 303 of the server 102 is “processing”. Accordingly, even if the image forming apparatus 101 issues a request for confirmation of the print data after the resumption as in the above-described comparative examples, the list of the print data does not include the job 2 because the job 2 is “processing”. In this case, an opportunity to receive the print data of the job 2 is lost and thus the job 2 cannot be executed. Meanwhile, in the present exemplary embodiment, the control is performed as follows.

Upon the resumption, in step S1001, the image forming apparatus 101 confirms the print data identifier and the execution status of the print data stored in the HDD 203. Here, the execution status of the job 2 is “status 1”, i.e., a status in which receiving the print data of the print target is not complete. Accordingly, in step S1002, the image forming apparatus 101 issues a request for permitting downloading of the print data to the server 102, by using the print data identifier “a”. Step S1002 is similar to step S905 illustrated in FIG. 9. Afterward, the processing in and after step S906 in FIG. 9 is performed and thus, the print job of the job 2 can be executed. In this way, in the image forming apparatus 101 according to the present exemplary embodiment, the image forming apparatus 101 also stores information including the print data identifier and the execution status of the corresponding job in the HDD 203 that is a nonvolatile memory. The image forming apparatus 101 refers to the information, when a shutdown occurs due to an event such as a resumption. Further, the subsequent control can be appropriately switched according to the information.

### Verification Example 2

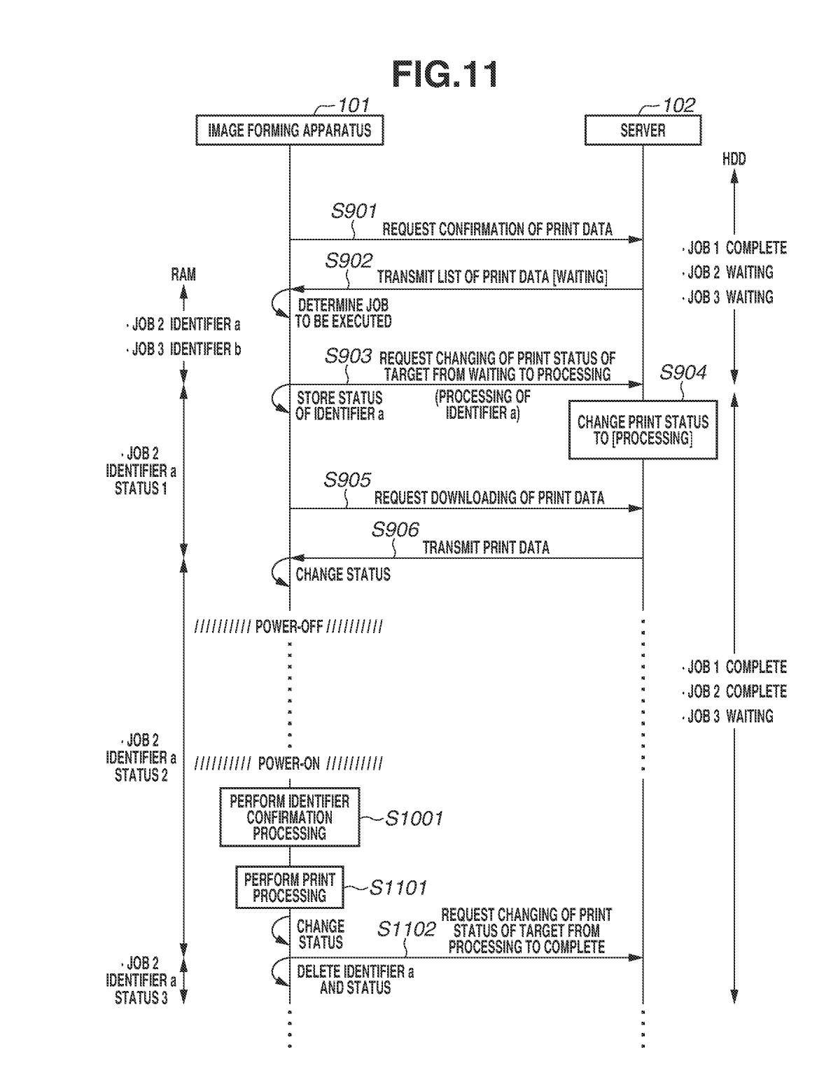

FIG. 11 illustrates an example in which a shutdown of the image forming apparatus 101 occurs, after the print data is transmitted from the server 102 to the image forming apparatus 101 in step S906. Steps similar to those in FIG. 9 are provided with the same step numbers as those in FIG. 9 and will not be described. More specifically, steps S901 to S906 are similar to those in FIG. 9 and will not be described.

After step S906, a shutdown of the image forming apparatus 101 occurs, and then a resumption takes place. Here, the information stored in the HDD 203 of the image forming apparatus 101 indicates the print data identifier “a” corresponding to the job 2, and “status 2” representing the execution status of the job. On the other hand, the execution status of the job 2 stored in the HDD 303 of the server 102 is “processing”. Accordingly, even if the image forming apparatus 101 issues a request for confirmation of the print data after the resumption as in the above-described comparative examples, the list of the print data does not include the job 2 because the job 2 is “processing”. In this case, an opportunity to reacquire the print data of the job 2 is lost and thus the job 2 cannot be executed. Meanwhile, in the present exemplary embodiment, the control is performed as follows.

Upon the resumption, in step S1001, the image forming apparatus 101 confirms the print data identifier and the execution status of the print data stored in the HDD 203. Here, the execution status of the job 2 is “status 2”, i.e., a status in which receiving the print data of the print target is complete, and the printing is in process. However, the print processing is not yet completed and thus, in step S1101, the image forming apparatus 101 executes the print processing similar to step S907 in FIG. 9, or resumes the print processing if the print processing has already started. If the print data received in step S906 is lost, the image forming apparatus 101 may begin from issuing a request for permitting downloading of the print data transmitted in step S905 again. Afterward, the processing in and after step S906 in FIG. 9 is performed and thus, the print job of the job 2 can be executed. In this way, in the image forming apparatus 101 according to the present exemplary embodiment, the image forming apparatus 101 also stores information including the print data identifier and the execution status of the corresponding job in the HDD 203 that is a nonvolatile memory. The image forming apparatus 101 refers to the information, when a shutdown occurs due to an event such as a resumption. Further, the subsequent control can be appropriately switched according to the information.

### Verification Example 3

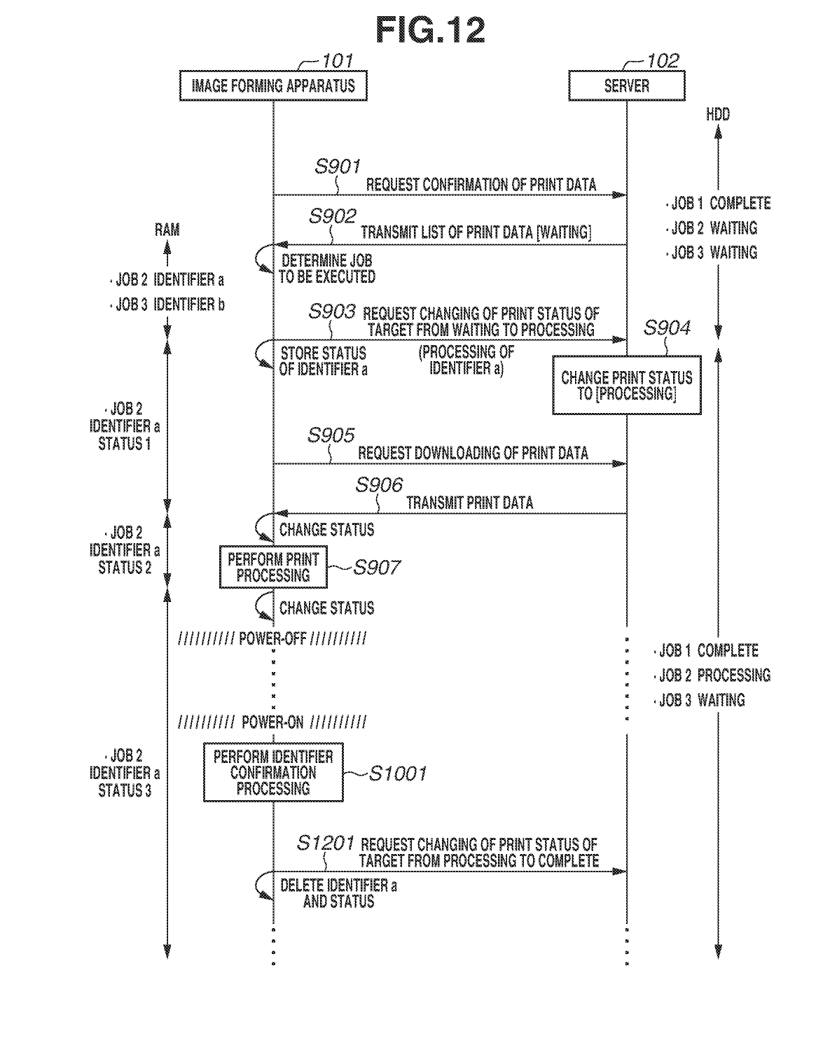

FIG. 12 illustrates an example in which a shutdown of the image forming apparatus 101 occurs, after the image forming apparatus 101 stars the print processing in step S907 and before the print processing is completed. Steps similar to those in FIG. 9 are provided with the same step numbers as those in FIG. 9 and will not be described. More specifically, steps S901 to S907 are similar to those in FIG. 9 and will not be described.

After step S907, a shutdown of the image forming apparatus 101 occurs, and then a resumption takes place. Here, the information stored in the HDD 203 of the image forming apparatus 101 indicates the print data identifier “a” corresponding to the job 2, and “status 3” representing the execution status of the job. On the other hand, the execution status of the job 2 stored in the HDD 303 of the server 102 is “processing”. Accordingly, even if the image forming apparatus 101 issues a request for confirmation of the print data after the resumption as in the above-described comparative examples, the list of the print data does not include the job 2 because the job 2 is “processing”. In this case, an opportunity to reacquire the print data of the job 2 is lost and thus the job 2 cannot be executed. Meanwhile, in the present exemplary embodiment, the control is performed as follows.

Upon the resumption, in step S1001, the image forming apparatus 101 confirms the print data identifier and the execution status of the print data stored in the HDD 203. Here, the execution status of the job 2 is “status 3”, i.e., a status in which the print processing is complete. However, the image forming apparatus 101 has not notified the server 102 of the completion of the print processing. Thus, in step S1201, the image forming apparatus 101 issues a request to the server 102, requesting for changing of the execution status of the job from “processing” to “complete”. Further, the image forming apparatus 101 deletes the print data identifier (here, “a”) and the status information from the HDD 203. Afterward, the processing in and after step S909 in FIG. 9 is performed and thus, the print job of the job 2 can be successfully executed. In this way, in the image forming apparatus 101 according to the present exemplary embodiment, the image forming apparatus 101 also stores information including the print data identifier and the execution status of the corresponding job in the HDD 203 that is a nonvolatile memory. The image forming apparatus 101 refers to the information, when a shutdown occurs due to an event such as a resumption. Further, the subsequent control can be appropriately switched according to the information.

### <Print Data Association Information>

Next, print data association information will be described with reference to FIG. 13. The print data association information is information used when the print data is managed in the server 102, in the print processing sequence illustrated in FIG. 9, after the client terminal 103 inputs the image data to the server 102.

The print data association information managed by the server 102 includes information indicating a printer ID 1301, the user ID 1302, the print data identifier 1303, the print data name 1304, the print status (execution status) 1305, and the input time 1306. The printer ID 1301 represents the identifier of a printer managed by the printer management unit 503. The printer management unit 503 manages various print attribute values of an image forming apparatus and the current status information of the image forming apparatus, by using the printer ID 1301.

The user ID 1302 is used for authentication for permitting the client terminal 103 to have access to the server 102. The user ID 1302 is associated with the user ID of an operator of the client terminal 103. The server 102 can identify which user ID has requested the printing from the client terminal 103.

The server 102 generates and manages the print data identifier 1303, for the print data input by the client terminal 103. The print data identifier 1303 is transmitted from the server 102 to the image forming apparatus 101 in step S902 described above. The print data identifier 1303 is thereby used for the print processing and the processing for notifying the execution status between the print data identifier 1303 and the server 102.

The management information screen generation unit 502 displays the print data name 1304 on a print data management screen, as the name of the print data input to the server 102. The image forming apparatus 101 may receive the print data name 1304 together with the print data, when downloading the print data in step S906. The message display unit 401 may then display the received print data name 1304 as the name of the print data on the operation unit 210.

The print status 1305 for each piece of print data includes a waiting status (corresponding to the status described above) indicating a status before start of printing, and a processing status (corresponding to the status 2 described above) in which the print processing is successfully performed. The print status 1305 further includes an interruption status, a cancellation status, and a completion status (corresponding to the status 3 described above). The interruption status indicates that the printing is interrupted for some reason in the image forming apparatus 101. The cancellation status indicates that the printing is cancelled. The completion status indicates that the printing is complete. Examples of the interruption status include running out of toner, no paper in the sheet feeding tray, opening of the cover, occurrence of a paper jam, in the image forming apparatus 101. According to the present exemplary embodiment, the image forming apparatus 101 notifies the server 102 of the execution status whenever necessary, and the server 102 manages the notified information as the execution status of a print job, as described above.

The input time 1306 is an input time of each job for which printing is requested. The input time 1306 indicates an input order. This information is used to determine a job to be processed next. Note that the print data association information may include other kind of information indicating the input order, in place of the input time 1306.

### <Processing Procedure>

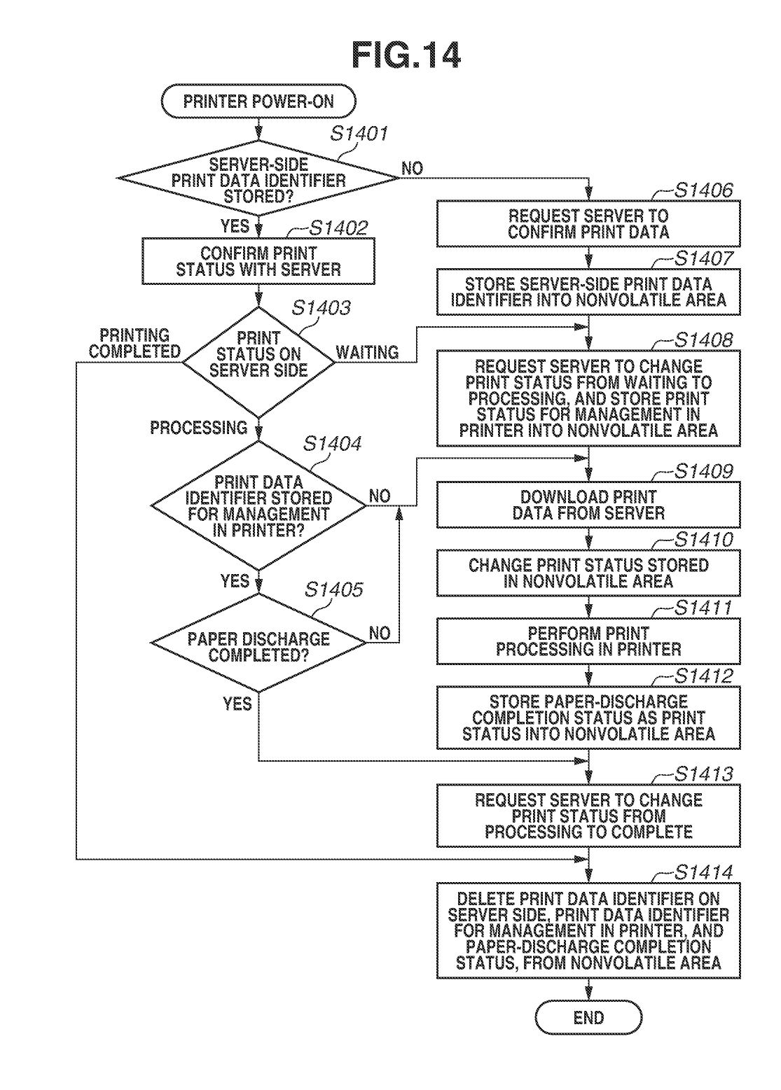

Next, a processing procedure will be described with reference to FIG. 14. The processing procedure is performed when the power is turned on, after a shutdown of the image forming apparatus 101 occurs in the sequence illustrated each of FIG. 9 to FIG. 12. The processing to be described below is implemented when, for example, the CPU 201 executes a control program in the RAM 202, by reading out the control program stored in the HDD 203. According to the present exemplary embodiment, in order to evade a trouble attributable to a shutdown during the printing, the image forming apparatus 101 stores the print data identifier 1303 generated and managed by the server 102, into a nonvolatile area such as the HDD 203, and manages the stored print data identifier 1303. In addition, the image forming apparatus 101 stores the print data identifier generated for the management of the image forming apparatus 101 during the print processing, together with the execution status, into the HDD 203. The image forming apparatus 101 manages these pieces of stored information. The subsequent control is thereby switched according to the combination of the execution status in the nonvolatile area on the image forming apparatus 101 side and the execution status on the server 102 side.

First, in step S1401, upon the subsequent power-on of the image forming apparatus 101, the print application 404 determines whether the print data identifier 1303 is stored in a nonvolatile area such as the HDD 203. If the print data identifier 1303 is stored (YES in step S1401), the execution of a print job corresponding to the print data identifier 1303 has started before the occurrence of a shutdown, and at least the processing in step S902 described above is complete. In this case, the processing proceeds to step S1402. Otherwise (NO in step S1401), the processing proceeds to step S1406.

In step S1402, the print application 404 requests the server 102 to confirm the execution status (print status) of the job corresponding to the print data identifier 1303, via the network transmission and reception unit 405. More specifically, the print application 404 transmits to the server 102 an inquiry about the execution status of the print data corresponding to the print data identifier 1303, by using the print data identifier 1303. Upon receiving the inquiry via the network transmission and reception unit 505, the print data management unit 501 provides the print status 1305 corresponding to the print data identifier 1303 to the image forming apparatus 101, as a response.

Next, in step S1403, the print application 404 confirms the print status 1305 of the print data notified by the server 102. If the execution status is “processing”, the processing proceeds to step S1404. If the execution status is “complete”, the processing proceeds to step S1414. If the execution status is “waiting”, the processing proceeds to step S1408. If the execution status is “processing”, at least step S904 is completed before the occurrence of the shutdown. In this case, in step S1404, the print application 404 determines whether the print data identifier generated and managed in the image forming apparatus 101 during the print processing is stored in the HDD 203. If the print data identifier is stored (YES in step S1404), the processing proceeds to step S1405. Otherwise (NO in step S1404), the processing proceeds to step S1409.

In the case where the print data identifier is stored, at least step S907 has started before the occurrence of the shutdown. In this case, in step S1405, the print application 404 confirms whether a status, which indicates whether paper discharge processing for all the print data is completed, is stored in the HDD 203 in step S907 before the occurrence of the shutdown. If the status is stored (YES in step S1405), the processing proceeds to step S1413. Otherwise (NO in step S1405), the processing proceeds to step S1409.

In the case where the paper discharge processing for all the print data is complete, the execution status in the server 102 is “processing”, even though the paper discharge is finished as described with reference to FIG. 12. In this case, in step S1413, the print application 404 requests the server 102 to change the execution status from “processing” to “complete”, via the network transmission and reception unit 405. Upon receipt of the request via the network transmission and reception unit 505, the print data management unit 501 changes the print status 1305 of the applicable print data to “complete”, and notifies the image forming apparatus 101 of the change.

Afterward, in step S1414, the print application 404 deletes the print data identifier 1303, the print data identifier generated and managed during the print processing in the image forming apparatus 101, and the information indicating the paper-discharge completion status, from the HDD 203.

In the case where the execution status on the server 102 side is “complete” in step S1403, the processing is completed up to step S909 before the occurrence of the shutdown, and the shutdown has occurred in a state that step S1414 is not yet performed. Accordingly, in this case, step S1414 is executed.

Further, in the case where the execution status on the server 102 side is “waiting” in step S1403, the print processing has started before the occurrence of the shutdown and at least step S902 is completed. In this case, in step S1408, the print application 404 requests the server 102 to change the execution status from “waiting” to “processing” via the network transmission and reception unit 405. Upon receipt of the request via the network transmission and reception unit 505, the print data management unit 501 changes the print status 1305 of the applicable print data to “processing”, and notifies the image forming apparatus 101 of the change. Further, here, the print processing unit 403 generates the print data identifier to be managed during the print processing in the image forming apparatus 101, and notifies the print application 404 of the generated print data identifier. Furthermore, the print application 404 associates the execution status (the status 1) with the print data identifier, and stores the execution status into the HDD 203.

In step S1409, the print application 404 issues a request for permitting downloading of the print data to the server 102, via the network transmission and reception unit 405. The request includes downloading of not only the print data for which paper is to be discharged in the image forming apparatus 101, but also print properties including specification of polychrome printing and specification of two-sided printing. The print properties and the print data may be transmitted in separate requests for downloading. Upon receipt of the request via the network transmission and reception unit 505, the print data management unit 501 provides the applicable print data and information representing print attribute values necessary for the printing, to the image forming apparatus 101, as a response.

Upon receipt of the print data and the print attribute values by the print application 404, the processing proceeds to step S1410. In step S1410, the print application 404 passes the data received from the server 102, to the print processing unit 403, and issues a print start request. In addition, the print application 404 changes the execution status stored in the HDD 203, to the status (the status 2) in which the acquisition of the print data is complete and the print processing has started.

In step S1411, upon receiving the print start request, the print processing unit 403 executes the print processing by using the print data and the print attribute values received from the print application 404. Upon completion of the print processing, the processing proceeds to step S1412. In step S1412, the print processing unit 403 notifies the print application 404 of the completion of printing. The completion of printing indicates the completion of paper discharge for the print data. Upon being notified of the completion of printing from the print processing unit 403, the print application 404 changes the execution status to be stored in the HDD 203 to the paper-discharge completion status (the status 3), and the paper-discharge completion status is stored into the HDD 203. The print application 404 then executes the above-described processing in and after step S1413.

On the other hand, in the case where the print data identifier 1303 is not stored in the HDD 203 in step S1401, at least only step S901 is completed before the occurrence of the shutdown, or there is no occurrence of a shutdown, and printing begins as new processing. In this case, in step S1406, the print application 404 issues a request for confirmation of print data to the server 102. Upon receipt of the request via the network transmission and reception unit 505, the print data management unit 501 provides list information to the image forming apparatus 101, as a response. The list information indicates a list of print data to be printed using the printer ID 1301 corresponding to the image forming apparatus 101. The list information included in the response includes the print data identifier 1303 generated and assigned on the server 102.

Next, in step S1407, the print application 404 stores the print data identifier 1303 returned from the server 102 in step S1406 into the HDD 203, and performs the processing in and after 51408. Further, the print application 404 stores the status (the status 1) indicating incompletion of the receipt of the print data into the HDD 203, together with the print data identifier 1303.

In the case where the print data identifier generated and managed in the image forming apparatus 101 is not stored in step S1404, the current status is a status (the status 2) that cannot be resolved by only performing the reprinting processing from the beginning again as described with reference to FIG. 7. The status is similar to the status in the case where the print application 404 determines in step S1405 that the paper discharge processing for all the print data is not completed.

In this case, instead of performing the reprinting processing upon power-on again from step S1401, the print application 404 performs the processing from step S1409 and thereafter, by using the print data identifier 1303 stored in the HDD 203.

As described above, according to the present exemplary embodiment, the image forming apparatus 101 requests a list of jobs managed by the server 102, and acquires data of a predetermined job and the identifier of the predetermined job from the list of jobs provided by the server 102. The image forming apparatus 101 then stores the acquired information into the HDD 203 that is a nonvolatile area. Further, upon start of the execution of the predetermined job, the image forming apparatus 101 stores first information indicating the execution status of the predetermined job into the HDD 203. Afterward, according to a change in the execution status of the predetermined job, the image forming apparatus 101 requests a change to second information indicating the execution status of the predetermined job managed in the server 102, and changes the first information stored in the HDD 203. In addition, when a resumption due to a shutdown occurs, the image forming apparatus 101 confirms the identifier stored in the HDD 203, and the first information corresponding to the identifier, and resumes the predetermined job corresponding to the confirmed identifier, according to the first information. With this configuration, even if a shutdown of the image forming apparatus 101 occurs during the processing of a print job input from the server 102, resumption processing can be executed according to the execution status of the job at that time. This can resolve issues described with reference to FIGS. 7 and 8, such as missing the execution of a job.

The present invention is variously modifiable without being limited to the above-described exemplary embodiment. For example, described in the exemplary embodiment is the case where a shutdown occurs during the execution of a print job. However, embodiments of the present invention are applicable to all cloud services provided by an image forming apparatus. In other words, in the image forming apparatus 101, embodiments of the present invention are applicable to any job if the image forming apparatus 101 executes the job by acquiring data about the job from the server 102. In this case, the image forming apparatus 101 and the server 102 each store an execution status according to a job execution procedure, so that an effect similar to that in the above-described exemplary embodiment can be obtained.

A second exemplary embodiment of the present invention will be described below. Described above in the first exemplary embodiment is a method for enabling the reprinting processing by an operation flow at the subsequent power-on after the occurrence of a shutdown. Some type of image forming apparatus may keep a power-on state for a predetermine time when an instruction for a shutdown is detected, and various kinds of termination processing may be performed in the meantime. In the present exemplary embodiment, a processing procedure in termination processing at power-off due to a shutdown will be described.

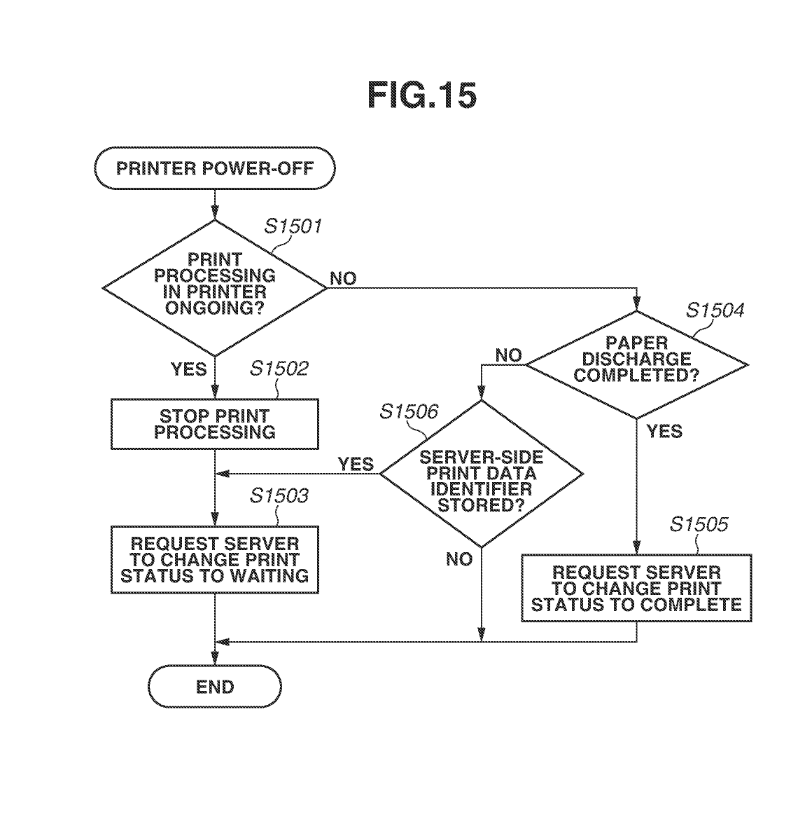

FIG. 15 illustrates a processing procedure to be performed when the print processing at a shutdown of the image forming apparatus 101 ends. The processing to be described below is implemented when, for example, the CPU 201 executes a control program in the RAM 202, by reading out the control program stored in the HDD 203. First, the power management unit 402 detects a shutdown of the image forming apparatus 101. The power management unit 402 then notifies start of termination processing due to the shutdown, to the print application 404. The processing illustrated as a flowchart thus begins.

In step S1501, the print application 404 determines whether the print processing in the image forming apparatus 101 described with reference to step S1411 is ongoing. Here, if the execution status stored in the HDD 203 is the status 1 or the status 2, the print application 404 determines that the print processing is ongoing. If the print processing is ongoing (YES in step S1501), the processing proceeds to step S1502. Otherwise (NO in step S1501), the processing proceeds to step S1504.

In step S1502, the print application 404 issues a request for stopping the print processing to the print processing unit 403. Upon receipt of the request for stopping, the print processing unit 403 stops the paper discharge processing, and notifies the print application 404 of the stop. Next, in step S1503, the print application 404 issues a request for changing the execution status to “waiting” to the server 102, via the network transmission and reception unit 405. This ends the processing. Upon receiving the request via the network transmission and reception unit 505, the print data management unit 501 changes the print status 1305 of the applicable print data to “waiting”, and notifies the image forming apparatus 101 of the change.

On the other hand, in the case where the print application 404 determines that the print processing is not ongoing in step S1501, the print processing has not started yet in the image forming apparatus 101, or the paper discharge for all the print data is completed. In this case, in step S1504, the print application 404 determines whether the paper discharge processing for all the print data is completed. Step S1504 is similar to step S1405. Here, if the execution status stored in the HDD 203 is the status 3, the print application 404 determines that the paper discharge processing is completed. If the paper discharge processing is completed (YES in step S1504), the processing proceeds to step S1505. Otherwise (NO in step S1504), the processing proceeds to step S1506.

If the paper discharge processing for all the print data is completed, then in step S1505, the print application 404 requests the server 102 to change the execution status to “complete”, via the network transmission and reception unit 405. This ends the processing. Upon receiving the request via the network transmission and reception unit 505, the print data management unit 501 changes the print status 1305 of the applicable print data to “complete”, and notifies the image forming apparatus 101 of the completion of the change.

On the other hand, if the paper discharge processing for all the print data is not completed, the print processing in the image forming apparatus 101 has not started yet. In this case, in step S1506, the print application 404 determines whether the print data identifier 1303 is already acquired from the server 102. Step S1506 is similar to step S1401. If the print data identifier 1303 is already acquired (YES in step S1506), the processing proceeds to step S1503. Otherwise (NO in step S1506), the print processing has not performed in the first place, or the print processing is to begin, and thus the processing ends.

As described above, according to the present exemplary embodiment, in the termination processing performed when a shutdown of the image forming apparatus 101 occurs, the image forming apparatus 101 confirms the identifier and the execution status (the first information) stored in the HDD 203. The image forming apparatus 101 then requests the server 102 to change the second information (to “waiting” or “complete”) as necessary. According to the present exemplary embodiment, the execution status on the server 102 side is changed and thus the execution status is “waiting” (or “complete”) in a case where the reprinting processing is necessary at the subsequent power-on. Accordingly, the print processing can be performed from step S1401 if necessary.

The print application 404 may change the execution status to an error in step S1503. In this case, in the reprinting processing performed at the subsequent power-on, the execution status in step S1403 is detected as an error. The print application 404 changes the execution status in the server 102 to “processing”, in order to perform the reprinting processing from the error status. Afterward, the flow of the operation in and after S1404 is performed and thus, the reprinting processing can be performed.

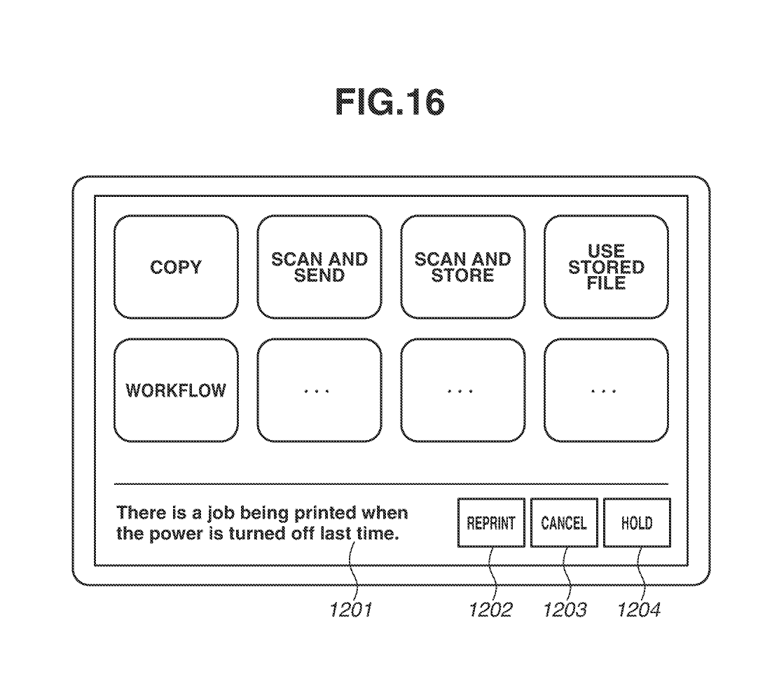

A third exemplary embodiment of the present invention will be described below. To be described below in the present exemplary embodiment is a configuration example in which presence/absence of the reprinting processing is selected in the flowchart according to FIG. 14 starting at the subsequent power-on. FIG. 16 is predicated on the print data identifier 1303 being already acquired in step S1401. Immediately before step S1408 or S1409, the print application 404 displays information illustrated in FIG. 16 on the operation unit 210 via the message display unit 401.

In the flowchart according to FIG. 14, the print processing that has started at the previous power-off automatically begins at the subsequent power-on. This may be displayed as a message 1201 to the operator of the image forming apparatus 101, together with options. The options include an option 1202 that indicates execution of reprinting, an option 1203 that indicates cancellation of processing without performing reprinting, and an option 1204 that indicates holding of execution and cancellation of reprinting.

If the reprinting is selected, the print application 404 continues step S1408 or S1409 and thereafter as illustrated in FIG. 14. If the cancellation is selected, the print application 404 changes the execution status in the server 102 to cancellation, and then performs step S1414. This ends the print processing. Alternatively, if the holding is selected, the print application 404 suspends the flowchart according to FIG. 14. The print application 404 then displays the message 1201 as well as the options 1202 to 1204, after a lapse of a predetermined time, or upon the completion of another print processing, or at the subsequent power-on of the image forming apparatus 101.

In a case where a shutdown occurs during printing, the print processing may be unnecessary to the operator of the image forming apparatus 101. According to the present exemplary embodiment, such needless printing can be prevented by providing the above-described options.

According to the present exemplary embodiments, even if a shutdown of an apparatus occurs in a period between start and end of a job, the apparatus can suitably execute resumption processing when the power is subsequently turned on, and accurate processing for notifying a network server of an execution status.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-160690, filed Aug. 18, 2016, which is hereby incorporated by reference herein in its entirety.

What is claimed is:

1. An image forming apparatus capable of communicating with a server, and including a nonvolatile storage unit capable of storing information and an image forming unit for forming an image on a sheet based on print data, the image forming apparatus comprising one or a plurality of control units including a processor or a processing circuit for executing a program in a memory, the control unit being configured to perform:
acquiring identification information of print data;
acquiring the print data indicated by the identification information from the server;
causing the image forming unit to execute image formation based on the print data;
storing, after completion of the image formation, information indicating that the completion is not yet notified to the server into the storage unit and updating, after the completion of the image formation is notified to the server, the information so that the information indicates that the completion has been notified to the server; and
notifying the server of the completion of the image formation, without resuming the image formation, based on the information indicating that the completion is not yet notified to the server when the image forming apparatus is powered on.

2. The image forming apparatus according to claim 1, wherein, when the image forming apparatus is powered on, the control unit acquires identification information of print data for which image formation completion notification is not acquired by the server.

3. The image forming apparatus according to claim 1, wherein the control unit stores the identification information into the storage unit before the completion of the image formation is notified to the server, and deletes the identification information from the storage unit after the completion of the image formation is notified to the server.

4. The image forming apparatus according to claim 1, further comprising a display unit configured to display information,
wherein the control unit determines that the completion of the image formation is not yet notified to the server when the image forming apparatus is powered on, and causes the display unit to display information about an interrupted job.

5. The image forming apparatus according to claim 4, wherein the control unit causes the display unit to display a screen related to an instruction for resuming the interrupted job, as the information about the interrupted job.

6. The image forming apparatus according to claim 5, wherein the control unit determines that an interrupted job is present based on identification information of print data being stored in the storage unit when the image forming apparatus is powered on.

7. An image forming apparatus capable of communicating with a server, and including a nonvolatile storage unit capable of storing information and an image forming unit for forming an image on a sheet based on print data, the image forming apparatus comprising one or a plurality of control units including a processor or a processing circuit for executing a program in a memory, the control unit being configured to perform:
acquiring identification information of print data;
acquiring the print data indicated by the identification information from the server;
storing information indicating that the print data has been received and that completion of image formation is not yet notified to the server;
causing the image forming unit to execute the image formation based on the print data;
updating, after the completion of the image formation is notified to the server, the information so that the information indicates that the completion has been notified to the server; and
causing the image forming unit to execute the image formation based on the print data, without starting receipt of the print data from the server, based on the information indicating that the completion is not yet notified to the server when the image forming apparatus is powered on.

8. The image forming apparatus according to claim 7, wherein, when the image forming apparatus is powered on, the control unit acquires identification information of print data for which image formation completion notification is not acquired by the server.

9. The image forming apparatus according to claim 7, wherein the control unit stores the identification information into the storage unit before the completion of the image formation is notified to the server, and deletes the identification information from the storage unit after the completion of the image formation is notified to the server.

10. The image forming apparatus according to claim 7, further comprising a display unit configured to display information,
wherein the control unit determines that the completion of the image formation is not yet notified to the server when the image forming apparatus is powered on, and causes the display unit to display information about an interrupted job.

11. The image forming apparatus according to claim 10, wherein the control unit causes the display unit to display a screen related to an instruction for resuming the interrupted job, as the information about the interrupted job.

12. The image forming apparatus according to claim 11, wherein the control unit determines that an interrupted job is present based on identification information of print data being stored in the storage unit when the image forming apparatus is powered on.

13. An image forming apparatus capable of communicating with a server, and including a nonvolatile storage unit capable of storing information and an image forming unit for forming an image on a sheet based on print data, the image forming apparatus comprising one or a plurality of control units including a processor or a processing circuit for executing a program in a memory, the control unit being configured to perform:
acquiring identification information of print data;
acquiring the print data indicated by the identification information from the server;
causing the image forming unit to start image formation based on the print data;
storing information indicating that the image formation is not yet completed and indicating a progress status of the image formation;
updating, after the completion of the image formation, the information so that the information indicates the completion of the image formation; and
executing resumption processing for the image formation starting not from a top page but from an intermediate page, based on the information indicating that the image formation is not yet completed when the image forming apparatus is powered on.

14. The image forming apparatus according to claim 13, wherein, when the image forming apparatus is powered on, the control unit acquires identification information of print data for which image formation completion notification is not acquired by the server.

15. The image forming apparatus according to claim 13, wherein the control unit stores the identification information into the storage unit before the completion of the image formation is notified to the server, and deletes the identification information from the storage unit after the completion of the image formation is notified to the server.

16. The image forming apparatus according to claim 13, further comprising a display unit configured to display information,
wherein the control unit determines that the completion of the image formation is not yet notified to the server when the image forming apparatus is powered on, and causes the display unit to display information about an interrupted job.

17. The image forming apparatus according to claim 16, wherein the control unit causes the display unit to display a screen related to an instruction for resuming the interrupted job, as the information about the interrupted job.

18. The image forming apparatus according to claim 17, wherein the control unit determines that an interrupted job is present based on identification information of print data being stored in the storage unit when the image forming apparatus is powered on.

19. A control method of an image forming apparatus capable of communicating with a server, and including a nonvolatile storage unit capable of storing information and an image forming unit for forming an image on a sheet based on print data, the control method comprising causing one or a plurality of control units, which is/are included in the image forming apparatus, including a processor or a processing circuit for executing a program in a memory, to perform:
acquiring identification information of print data;
acquiring the print data indicated by the identification information from the server;
causing the image forming unit to execute image formation based on the print data;
storing, after completion of the image formation, information indicating that the completion is not yet notified to the server into the storage unit and updating, after the completion of the image formation is notified to the server, the information so that the information indicates that the completion has been notified to the server; and
notifying the server of the completion of the image formation, without resuming the image formation, based on the information indicating that the completion is not yet notified to the server when the image forming apparatus is powered on.

20. A control method of an image forming apparatus capable of communicating with a server, and including a nonvolatile storage unit capable of storing information and an image forming unit for forming an image on a sheet based on print data, the control method comprising causing one or a plurality of control units, which is/are included in the image forming apparatus, including a processor or a processing circuit for executing a program in a memory, to perform:
acquiring identification information of print data;
acquiring the print data indicated by the identification information from the server;
storing information indicating that the print data has been received and that completion of image formation is not yet notified to the server;
causing the image forming unit to execute the image formation based on the print data;
updating, after the completion of the image formation is notified to the server, the information so that the information indicates that the completion has been notified to the server; and
causing the image forming unit to execute the image formation based on the print data, without starting receipt of the print data from the server, based on the information indicating that the completion is not yet notified to the server when the image forming apparatus is powered on.

21. A control method of an image forming apparatus capable of communicating with a server, and including a nonvolatile storage unit capable of storing information and an image forming unit for forming an image on a sheet based on print data, the control method comprising causing one or a plurality of control units, which is/are included in the image forming apparatus, including a processor or a processing circuit for executing a program in a memory, to perform:
acquiring identification information of print data;
acquiring the print data indicated by the identification information from the server;
causing the image forming unit to start image formation based on the print data;
storing information indicating that the image formation is not yet completed and indicating a progress status of the image formation;
updating, after the completion of the image formation, the information so that the information indicates the completion of the image formation; and
executing resumption processing for the image formation starting not from a top page but from an intermediate page, based on the information indicating that the image formation is not yet completed when the image forming apparatus is powered on.

22. A non-transitory storage medium that stores a program for causing an image forming apparatus to execute control processing, the image forming apparatus being capable of communicating with a server, and including a nonvolatile storage unit capable of storing information and an image forming unit for forming an image on a sheet based on print data, the control processing comprising causing one or a plurality of control units, which is/are included in the image forming apparatus, including a processor or a processing circuit for executing a program in a memory, to perform:
acquiring identification information of print data;
acquiring the print data indicated by the identification information from the server;
causing the image forming unit to execute image formation based on the print data;
storing, after completion of the image formation, information indicating that the completion is not yet notified to the server into the storage unit and updating, after the completion of the image formation is notified to the server, the information so that the information indicates that the completion has been notified to the server; and
notifying the server of the completion of the image formation, without resuming the image formation, based on the information indicating that the completion is not yet notified to the server when the image forming apparatus is powered on.

23. A non-transitory storage medium that stores a program for causing an image forming apparatus to execute control processing, the image forming apparatus being capable of communicating with a server, and including a nonvolatile storage unit capable of storing information and an image forming unit for forming an image on a sheet based on print data, the control processing comprising causing one or a plurality of control units, which is/are included in the image forming apparatus, including a processor or a processing circuit for executing a program in a memory, to perform:
acquiring identification information of print data;
acquiring the print data indicated by the identification information from the server;
storing information indicating that the print data has been received and that completion of image formation is not yet notified to the server;
causing the image forming unit to execute the image formation based on the print data;
updating, after the completion of the image formation is notified to the server, the information so that the information indicates that the completion has been notified to the server; and
causing the image forming unit to execute the image formation based on the print data, without starting receipt of the print data from the server, based on the information indicating that the completion is not yet notified to the server when the image forming apparatus is powered on.

24. A non-transitory storage medium that stores a program for causing an image forming apparatus to execute control processing, the image forming apparatus being capable of communicating with a server, and including a nonvolatile storage unit capable of storing information and an image forming unit for forming an image on a sheet based on print data, the control processing comprising causing one or a plurality of control units, which is/are included in the image forming apparatus, including a processor or a processing circuit for executing a program in a memory, to perform:
acquiring identification information of print data;
acquiring the print data indicated by the identification information from the server;
causing the image forming unit to start image formation based on the print data;
storing information indicating that the image formation is not yet completed and indicating a progress status of the image formation;
updating, after the completion of the image formation, the information so that the information indicates the completion of the image formation; and
executing resumption processing for the image formation starting not from a top page but from an intermediate page, based on the information indicating that the image formation is not yet completed when the image forming apparatus is powered on.
